(19) United States
(12) Patent Application Publication
(10) Pub. No.: US 2026/0131243 A1
(43) Pub. Date: May 14, 2026

(54) IMAGE PROCESSING METHOD, IMAGE PROCESSING APPARATUS, AND STORAGE MEDIUM

(71) Applicant: CANON KABUSHIKI KAISHA, Tokyo (JP)

(72) Inventors: Isao MATSUBARA, Tochigi (JP); Koshi HATAKEYAMA, Tokyo (JP); Toshihiro FUKUMOTO, Tokyo (JP)

(21) Appl. No.: 19/444,301

(22) Filed: Jan. 9, 2026

Related U.S. Application Data
(63) Continuation of application No. PCT/JP2024/023455, filed on Jun. 28, 2024.

(30) Foreign Application Priority Data
Sep. 8, 2023 (JP) 2023-146161

(51) Int. Cl. A63F 13/52; G06T 15/00; G06T 19/00

(52) U.S. Cl. CPC A63F 13/52; G06T 15/00; G06T 19/00

(57) ABSTRACT

An image processing method is configured to generate an image of an object using an imaging system in virtual space. A unique characteristic of the imaging system is associated with an NFT recorded on a blockchain. The image processing method includes acquiring a characteristic of an optical system included in the imaging system and spatial information on the object and the imaging system; and generating the image using information on the object, the characteristic of the optical system, and the spatial information.

### CROSS-REFERENCE TO RELATED APPLICATIONS

This application is a Continuation of International Patent Application No. PCT/JP2024/023455, filed on Jun. 28, 2024, which claims the benefit of Japanese Patent Application No. 2023-146161, filed on Sep. 8, 2023, both of which are hereby incorporated by reference herein in their entirety.

### BACKGROUND

### Field of the Technology

The aspect of the disclosure relates to one or more embodiments of an image processing method, an image processing apparatus, a storage medium.

### Description of the Related Art

Recently, cameras have been traded in a market in three-dimensional virtual space established inside a computer. ““In Shadow of the Colossus, players can freely capture images of beautiful scenery! A video explanation of notable “Photo Mode” in the PS4 version!”, Feb. 7, 2018, PlayStation. Blog, the Internet” discloses a technology of acquiring images by using a camera function in virtual space.

### SUMMARY

An image processing method is configured to generate an image of an object using an imaging system in virtual space. A unique characteristic of the imaging system is associated with an NFT recorded on a blockchain. The image processing method includes acquiring a characteristic of an optical system included in the imaging system and spatial information on the object and the imaging system; and generating the image using information on the object, the characteristic of the optical system, and the spatial information. An image processing apparatus corresponding to the above image processing method also constitutes another aspect of the disclosure. A storage medium storing a program that causes a computer to execute the above one or more control methods also constitutes another aspect of the disclosure.

Features of the present disclosure will become apparent from the following description of embodiments with reference to the attached drawings. The following description of embodiments is described by way of example.

### BRIEF DESCRIPTION OF THE DRAWINGS

FIG. 1 explains virtual space.

FIG. 2 is a block diagram of a virtual space service system.

FIGS. 3A and 3B illustrate an example of an image processing system imitated in real space.

FIGS. 4A, 4B, and 4C illustrate an object plane and an image plane in FIGS. 3A and 3B when viewed in a positive x-axis direction.

FIGS. 5A and 5B illustrate an example of an image processing system imitated in real space including a three-dimensional object.

FIG. 6 illustrates a specific example of an image processing system imitated in real space including a three-dimensional object.

FIGS. 7A to 7G illustrate an object plane and an image plane in FIG. 6 when viewed in the positive x-axis direction.

FIG. 8 explains occlusion processing.

FIGS. 9A and 9B illustrate examples of operation scenes.

FIG. 10 illustrates a camera and additionally purchased items.

FIGS. 11A and 11B illustrate shooting scenes.

FIG. 12 illustrates a shooting scene close to a live-action.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure. Corresponding elements in respective figures will be designated by the same reference numerals, and a duplicate description thereof will be omitted.

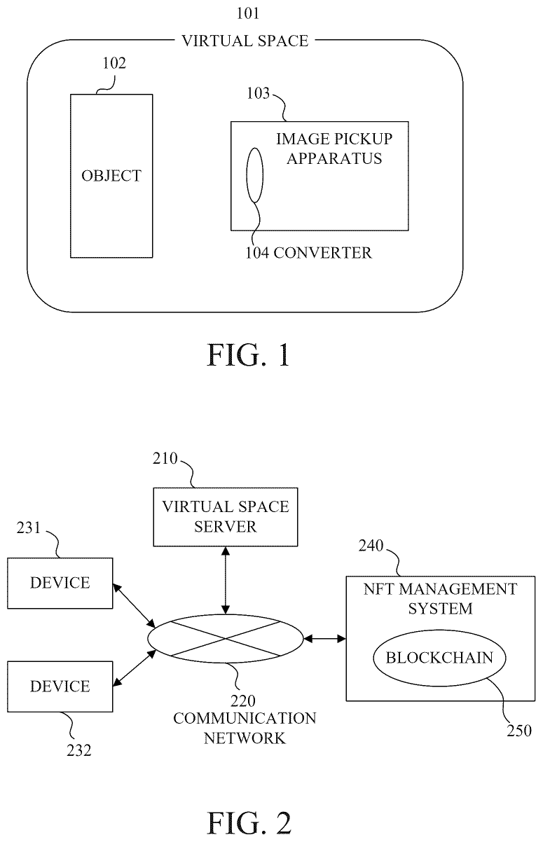

FIG. 1 explains virtual space 101. The virtual space 101 is, for example, a space developed in a computer. A specific example thereof is computer graphics (CG). An object 102 and an image pickup apparatus 103 are disposed in the virtual space 101.

The object 102 is a medium to be captured and is, for example, an object such as a person or a building disposed in the virtual space 101. The object 102 may be a planar or three-dimensional object.

The image pickup apparatus 103 is a device that converts the object 102 into an image, and corresponds to a camera in real space. The image pickup apparatus 103 may be conceptually recognized and may be a camera that does not exist in real space. The image pickup apparatus 103 includes a converter 104 having a function convert an object into an image. The converter 104 may correspond to a lens for a camera. A functional characteristic of the image pickup apparatus 103 is defined as a characteristic of the image pickup apparatus.

The image pickup apparatus 103 acquires an image including the object 102 in consideration of the characteristic of the image pickup apparatus. More specifically, an image including the object 102 is generated on a calculator in consideration of information corresponding to the characteristic of the image pickup apparatus. The image also depends on the relative positional relation between the object 102 and the image pickup apparatus 103. Thus, in acquiring the image, spatial information on the object 102 and the image pickup apparatus 103 may be considered.

The characteristic of the image pickup apparatus is unique (inherent) to each image pickup apparatus 103. For example, as each camera in real space had a unique manufacturing error, each image pickup apparatus 103 also has a unique characteristic. In real space, it is difficult to duplicate an object including its unique characteristic, but in virtual space, the object basically exists as electronic data, and thus it is possible to easily duplicate the characteristic of the image pickup apparatus. However, the image pickup apparatus 103 corresponds to a camera in real space, and it is problematic if the image pickup apparatus 103 is easily duplicated.

In order to prevent unauthorized duplication in virtual space, it is required to manage the characteristic of an image pickup apparatus as an asset. Accordingly, the unique characteristic of each image pickup apparatus 103 is managed by a non-fungible token (NFT). This makes it possible to maintain uniqueness of the image pickup apparatus 103. Moreover, by recording the NFT on a blockchain in association with the characteristic of the image pickup apparatus, the image pickup apparatus 103 is prevented from being freely duplicated. For example, a highly valuable old camera that exists only as a single unit in the world or a highly customized camera with various options can be prevented from being easily duplicated and losing its value as being unique or highly valuable.

FIG. 2 is a block diagram of a virtual space service system. A virtual space server 210 executes information processing for providing the virtual space 101. The virtual space server 210 transmits and receives data to and from a device 231 used by a user through a communication network 220 such as the Internet. The data transmission and reception can be observed from a device 232 used by another user. A device used by a user is, for example, a personal computer. The personal computer can make the virtual space 101 produced by CG appear as if the virtual space were a real space through a monitor that displays images. In addition, the image pickup apparatus 103 in the virtual space 101 can be operated by using a keyboard and a mouse. Moreover, a device used by a user functions as an image processing apparatus that acquires an image including an object using the image pickup apparatus 103 in the virtual space 101.

The image processing apparatus includes one or more memories storing instructions, and one or more processors that, upon execution of the instructions, operate to serve as the following first and second acquiring units. More specifically, such a device functions as a first acquiring unit acquires the characteristic of an optical system included in the image pickup apparatus 103 and spatial information on the object and the image pickup apparatus 103. Then, the device functions as a second acquiring unit that acquires an image by using the characteristic of the optical system and the spatial information.

The virtual space server 210 transmits and receives data to and from an NFT management system 240 through the communication network 220. The NFT management system 240 is an information processing system for managing NFT. An NFT managed by the NFT management system 240 is managed for its holder by being recorded and held on a blockchain 250. The holder of an NFT managed by the NFT management system 240 is authenticated by the blockchain 250. Through such a procedure, the characteristic of the image pickup apparatus can be prevented from being freely duplicated.

The image pickup apparatus 103 will be described below in more detail. The disclosure is directed to virtual space, but the characteristic of the image pickup apparatus may reflect the characteristic of a camera existing in real space. In this case, an image corresponding to an image captured by a camera existing in real space can be acquired. For ease of understanding a situation, description will be made in comparison with real space. As an example, the image pickup apparatus 103 will be described as a camera, and the characteristic of the image pickup apparatus will be described as the characteristic of a lens (characteristic of an optical system).

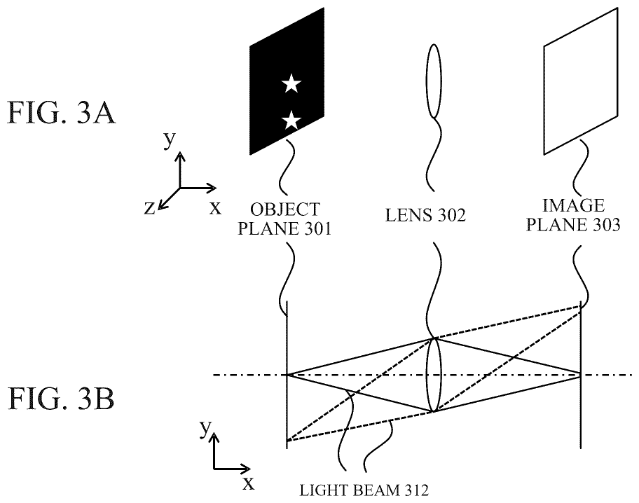

FIGS. 3A and 3B illustrate an example of an image processing system imitated in real space. FIG. 3A is a panoramic diagram of the image processing system. An object plane 301 corresponds to the object 102. A lens 302 corresponds to the converter 104. The lens 302 and an image plane 303 correspond to the image pickup apparatus 103, and an image formed on the image plane 303 is acquired by calculation to be described later. The lens 302 is disposed between the object plane 301 and the image plane 303.

FIG. 3B is a projection diagram of FIG. 3A when viewed in the positive z-axis direction. A light beam 312 emitted from each point on the object plane 301 enters the image plane 303, and an optical image is formed at each point on the image plane 303. In this case, the optical image on the image plane 303 typically forms a distribution having a certain extent rather than a point.

The characteristic of the image pickup apparatus can be represented by using, for example, a point spread function (PSF) indicating how a point on the object plane is spread on the image plane. The PSF is obtained by multiplying a distribution obtained by performing a discrete Fourier transform on a pupil function, the phase function of which corresponds to a wavefront aberration of an optical system, by a complex conjugate of the distribution. Since the PSF is suitable for representing the characteristic of a lens, the characteristic of the image pickup apparatus may be expressed by the PSF.

The characteristic of the image pickup apparatus in this embodiment is not limited to the PSF. For example, a spot diagram, an aberration coefficient, or an aberration shape may be used.

The spot diagram is obtained by plotting the positions of light beams on the image plane, the light beams having been emitted in a plurality of directions from a point on an object plane and passed through a lens. The spot diagram is a collection of points and thus difficult to be directly used for image calculation. However, the spot diagram can be converted into a distribution equivalent to the PSF by calculating a two-dimensional histogram.

A matrix for paraxial ray tracing is inversely calculated from the aberration coefficient, and paraxial ray tracing values for the entire angle of view are calculated from the matrix. A distribution equivalent to the PSF can be obtained by regarding the calculated values as a spot diagram and performing the same processing as described above.

A distribution equivalent to the PSF can be obtained by calculating a spot diagram from the aberration shape and then performing the same processing as described above.

In this manner, by using the aberration coefficient or the aberration shape, it is possible to check a final image from an early stage of design.

An image calculation method (image processing method) will be described below. An image may be acquired by convolution of the object 102, the characteristic of the image pickup apparatus, and the characteristic obtained from the spatial information. In the following, a case where the object 102 is a planar object and a case where the object 102 is a three-dimensional object will be sequentially described.

First, a case where the object 102 is a planar object will be described below. The PSF typically differs depending on a position on the image plane. The position on the image plane depends on the relative positional relation between the object 102 and the image pickup apparatus 103. Thus, the characteristic obtained from the spatial information is needed in addition to the characteristic of the image pickup apparatus.

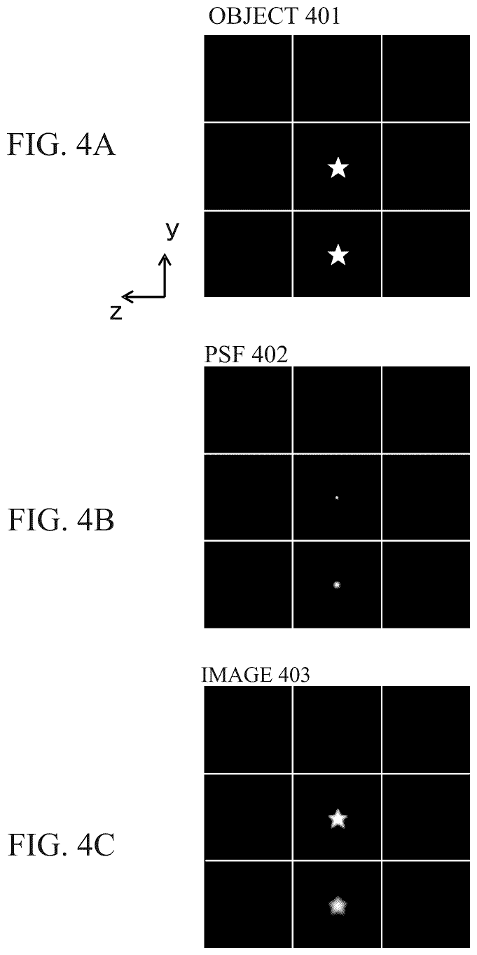

FIGS. 4A, 4B, and 4C illustrate the object plane 301 and the image plane 303 in FIGS. 3A And 3B when viewed in the positive x-axis direction. FIG. 4A illustrates an example of an object 401. FIG. 4B illustrates an example of a PSF 402. Since the PSF 402 differs depending on the position of the image plane, the area of the object is divided. In this example, the area is divided into 3×3. An image of each area can be obtained by performing convolution calculation between the object 401 and the PSF 402 for the area. FIG. 4C illustrates an image 403 obtained by integrating all images obtained by the convolution calculation. In a case where the central area is compared with the area below, the PSF 402 is sharper with less spread and the image 403 is sharper with less blur in the former. Accordingly, the image 403 corresponding to the PSF 402 is obtained for each area. Generally, an image of an object is formed in an inverted state both vertically and horizontally. However, in this embodiment, vertical and horizontal inversion processing is omitted to describe only the convolution processing. Accordingly, an image actually obtained on the image plane 303 is the image 403 that is vertically and horizontally inverted.

Although the object is monochromatic in this embodiment, the object may be colored. For a colored object, the image is typically expressed in three colors of RGB. Accordingly, as an example of a calculation method, a color image is obtained by performing the same processing for each of the three colors of RGB and integrating all images. Although the image is described as a still image in this embodiment, the image may be a motion image. An image of a motion image is obtained by performing the same calculation for each frame of the motion image and connecting the frames in a time series.

In the following description, the object 102 is a three-dimensional object. The PSF typically differs according to a distance (object distance) between an object and a lens. Thus, the characteristic of the image pickup apparatus differs for each object distance.

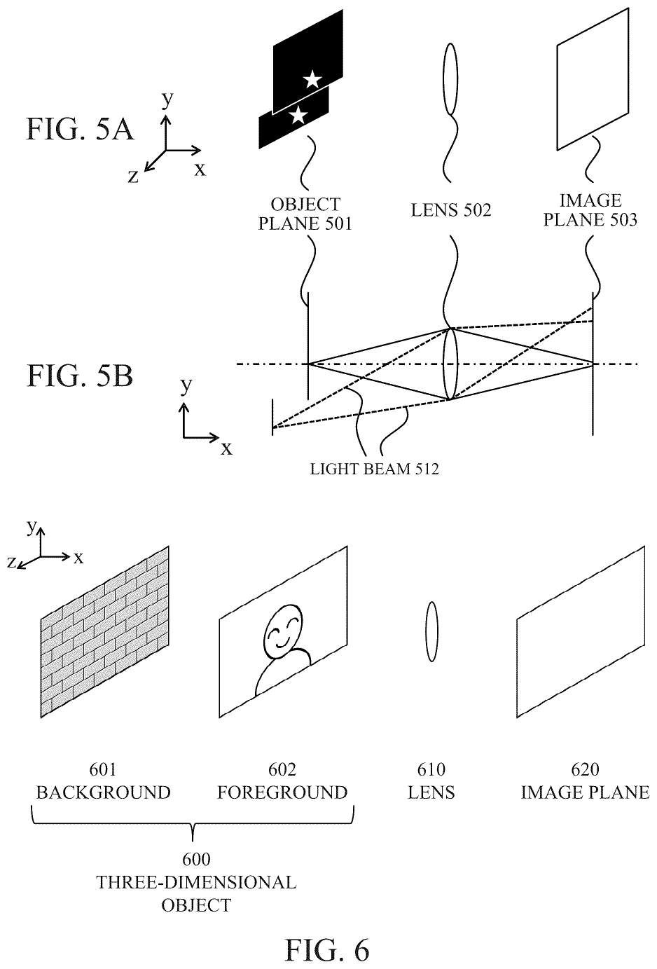

FIGS. 5A and 5B illustrate an example of an image processing system imitated in real space including a three-dimensional object. FIG. 5A is a panoramic diagram of the image processing system. FIG. 5B is a projection diagram of FIG. 5A when viewed in the positive z-axis direction.

As illustrated in FIG. 5B, an object 501 has an extent in the x-axis direction, and thus can be regarded as a three-dimensional object. The object 501 includes two star marks, and the lower star mark has a longer object distance than the central star mark. Typically, the distribution of the PSF widens relative to the PSF at an optimal position as an object distance change increases. A blurred image obtained by convolution with a largely changed PSF corresponds to what is called blur. In the case of a three-dimensional object as well, an image can be calculated by the same convolution calculation as for a planar object.

Basically, an image of a three-dimensional object having a plurality of object distances can be calculated in the same manner. However, in a case where an object distance is significantly different between adjacent areas of an object, an effect that an image intrudes into adjacent areas needs to be taken into consideration. In such a case, image calculation may be performed by classifying the spatial information into groups according to distance. Then, occlusion processing to be described later may be used as a method of integrating a plurality of images.

FIG. 6 illustrates a specific example of an image processing system imitated in real space including a three-dimensional object. A three-dimensional object 600 is constituted by a brick-patterned background 601 and a human foreground 602. A lens 610 is disposed between the three-dimensional object 600 and an image plane 620.

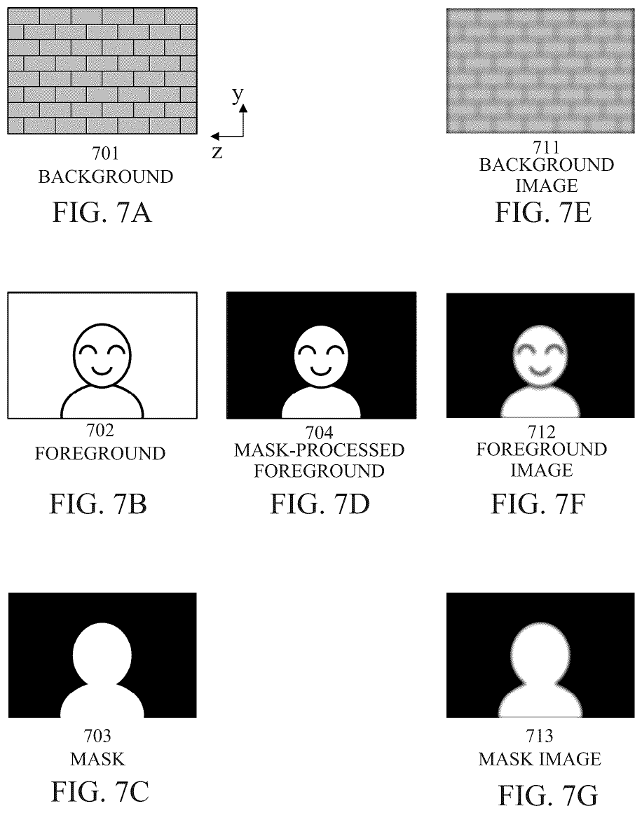

FIGS. 7A to 7G illustrate the object plane 301 and the image plane 303 in FIG. 6 when viewed in the positive x-axis direction. FIGS. 7A and 7B illustrate a background 701 and a foreground 702, respectively. FIG. 7C illustrates a mask 703 corresponding to the foreground 702. The mask 703 represents a portion where the foreground exists in white, and a portion where no foreground exists in black. In numerical processing, the white portion is recognized as “1,” and the black portion is recognized as “0.” A mask-processed foreground 704 illustrated in FIG. 7D is calculated by multiplying the foreground 702 and the mask 703.

Image calculation by convolution is performed on each of the background 701, the mask-processed foreground 704, and the mask 703. Through the image calculation, a background image 711, a foreground image 712, and a mask image 713 illustrated in FIGS. 7E to 7G are obtained. The background image 711, the foreground image 712, and the mask image 713 are examples of images calculated by assuming a state in which the camera focus is adjusted to the foreground 704. The foreground image 712 and the mask image 713 include the characteristic of the image pickup apparatus, in which blurring due to the lens is added. The background image 711 further includes the characteristic of the image pickup apparatus in which blurring due to defocus is considered.

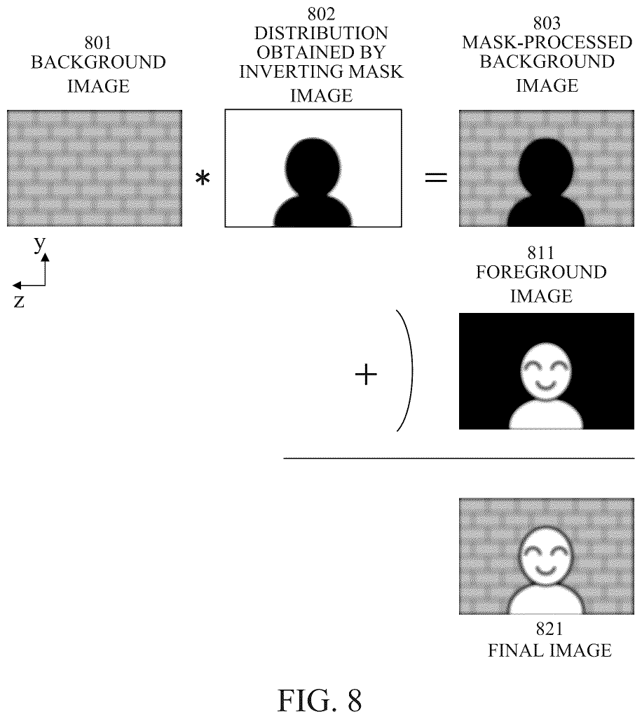

Occlusion processing for integrating a foreground image and a background image will be described below. FIG. 8 explains the occlusion processing. First, a distribution 802 obtained by inverting a mask image is calculated. The inversion is a distribution obtained by subtracting the distribution of the mask image from 1.0. White represents 1.0, black represents 0.0, and gray represents an intermediate value between them. A result obtained by multiplying a background image 801 and the distribution 802 obtained by inverting the mask image is a mask-processed foreground image 803. The mask-processed foreground image 803 and a foreground image 811 are added to obtain a final image 821. This processing constitute the occlusion processing.

The number of images to be integrated is two, e.g., a foreground and a background in FIG. 8, but may be three or more in reality. In such a case, this processing may be repeatedly performed. Moreover, although planes are used for the foreground and background, they may be three-dimensional objects. In a case of a three-dimensional object, for example, in a case where focusing is performed on eyes near the center of the foreground, peripheral portions of the foreground, such as ears and shoulders, are largely blurred. In this case, a higher effect is obtained through the occlusion processing.

The above procedure can provide an image in consideration of characteristics of an optical system included in the image pickup apparatus in virtual space, such as a lens shape and glass characteristic.

### First Embodiment

In this embodiment, for easy understanding, a specific description will be given while an image pickup apparatus in virtual space is associated with a camera in real space.

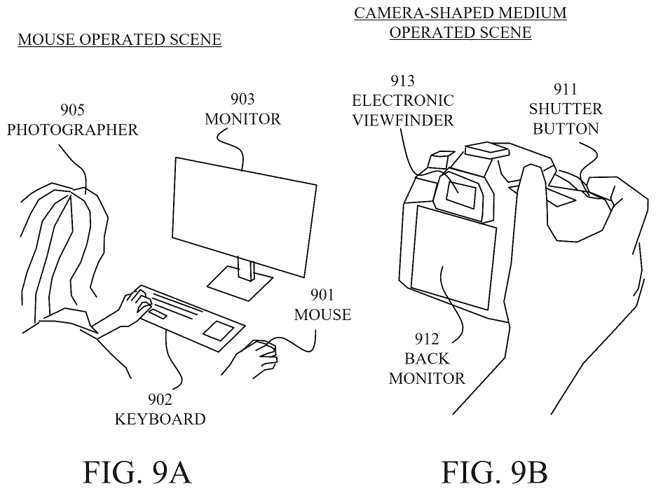

First, an operation method for shooting (imaging) and a device for performing the same will be described below. FIGS. 9A and 9B illustrate examples of operation scenes. FIG. 9A illustrates an operation scene with a mouse 901 and a keyboard 902, which are examples of user devices. A user device may be configured to allow a photographer 905 to operate while checking on an image displayed on a monitor 903, the status of a virtual space to be captured. An shooting operation (start of the image processing method) may be performed by clicking the mouse 901 or by pressing down a button of the keyboard 902. In this embodiment, a shooting operation example uses the mouse 901 and the keyboard 902, but the disclosure is not limited to this example and the operation may use a game controller or the like.

There may be considered a demand to perform shooting in accordance with motion in real space by the actual camera operation. FIG. 9B illustrates an operation scene with a camera-shaped medium (instrument) that is an example of a user device. An shooting operation may be performed by pressing down a shutter button 911 as in an actual camera. Thus, the medium may have a function of outputting a signal to the shutter button 911. The status of the virtual space may be checked by using a monitor or by using a back monitor 912 as in an actual camera. Alternatively, the status may be checked by using an electronic viewfinder 913. Through operations using the back monitor 912 and the electronic viewfinder 913, shooting can be performed in a state closer to shooting with an actual camera. Through the above-described operations, an image can be obtained with the image pickup apparatus in the virtual space.

In a case where a device in real space is linked with an image pickup apparatus in virtual space, the device in real space and the image pickup apparatus in virtual space may be associated by a blockchain. This corresponds to a situation in which the devices 231 and 232 are associated with a device on the virtual space server 210 by the blockchain 250 in FIG. 2. As one embodiment, in a case where an actual camera is purchased, an image pickup apparatus in a corresponding virtual space may be provided as a privilege. In this case, a purchaser of the actual camera also owns a camera in the virtual space.

Shooting in consideration of the characteristic of an image pickup apparatus in virtual space is valuable. Moreover, it is conceivable that owning an image pickup apparatus associated between virtual space and real space has new value. For example, in a case where an old camera is purchased, there may be a risk of failure if the product is extremely old, and in some cases, the product may actually be broken. In such a case as well, shooting in virtual space is available. In this manner, it is possible to perform shooting with a highly valuable camera, on a device such as a computer or in virtual space.

In a case where a new camera or lens is purchased, shooting can be performed under ideal conditions in virtual space in addition to shooting in real space and to perform comparison between them. In addition, it is possible to perform practice in virtual space before the user visits an actual shooting site. In real space, location hunting for finding a suitable shooting place is generally a hard task, but location hunting can be easily performed in virtual space. Shooting in virtual space has advantages other than location hunting. For example, in a case where an object is a person, it is generally difficult to have an opportunity for shooting in real space. Even if such an opportunity is obtained, there is a problem that, for example, a desired image cannot be captured due to tension. Even in such person shooting, since shooting can be freely performed in virtual space, shooting can be more focused to acquire an image closer to an ideal. There is also an advantage that shooting in virtual space serves as good practice for person shooting in real space.

### Second Embodiment

In the first embodiment, the characteristic of an image pickup apparatus corresponds to an actual camera. This embodiment will discuss an example utilizing advantages of virtual space, such as customization of a product that does not actually exist, a lens having performance that cannot be physically produced, or a lens that is difficult to produce due to product restriction, cost, or the like. In addition, processing corresponding to update in real space as part of customization will be described below.

Although it is attractive to reproduce, in virtual space, a camera existing in real space, there is another attraction in that a camera that does not exist in real space can be realized in virtual space. Accordingly, characteristics of an image pickup apparatus may include characteristics that do not exit or cannot exist. More specifically, an example is a user-designed lens. A user-designed lens is, for example, a lens designed by a camera user rather than a camera manufacturer, and is a lens that is not manufactured in reality. Other examples are optical design values, values indicating imaging characteristics such as aberration values, and camera control mechanisms. The optical design values are, for example, the curvature radius, thickness, distance, and refractive index of a lens. Machining is difficult in some cases depending on design values. Even in such a case, machining is possible in virtual space. The values indicating imaging characteristics such as aberration values are desired values at the time of design or during design. The camera control mechanisms are devices for image stabilization and the like.

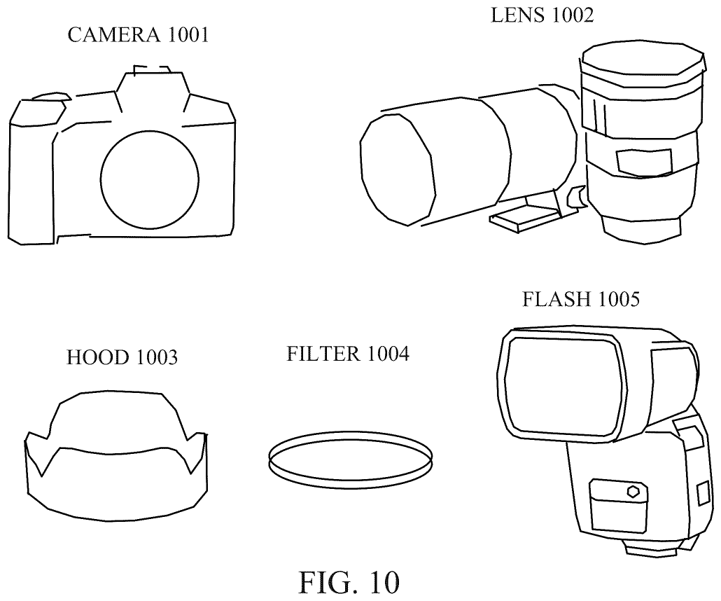

In real space, it is conceivable that, after a camera is purchased, software is updated or a lens or the like is additionally purchased in order to enhance performance. FIG. 10 illustrates a camera 1001 and additionally purchased items such as a lens 1002, a hood 1003, a filter 1004, and a flash 1005. The hood 1003 is attached to the lens 1002 to cut unnecessary light. The filter 1004 lowers light quantity or reduces light in a specific polarization direction. For example, the flash 1005 supplements insufficient light quantity during shooting or adds a taste to an image. Generally, with the additionally purchased items, a more preferable image can be acquired.

In virtual space, functions may be improved similarly to products in real space. In this case, NFT association may be changed along with them. Moreover, only a specific user associated with an NFT may be allowed to use. More specifically, the NFT management system 240 may be used to write to the blockchain 250.

As in real space, it is conceivable that resale is performed in virtual space. Items corresponding to the camera 1001 and the lens 1002 can be separately resold, but it is conceivable that updates and additionally purchased items are resold as a whole. In this case, the updates and additionally purchased items may be transferred as a whole on NFT as well. More specifically, the NFT management system 240 may be used to write to the blockchain 250.

### Third Embodiment

Recently, photo contests have been performed in virtual space. In this embodiment, shooting for exhibiting in a photo contest is performed.

It is conceivable that, in a photo contest, a variety of functions of an image pickup apparatus are used than in normal use. Accordingly, characteristics of the image pickup apparatus may include a variety of characteristics of an actual camera. Thereby, an image closer to real space can be acquired.

Specific examples of the various characteristics include aperture size, transmittance, thin film characteristic, manufacturing error, ghost, flare, and noise corresponding to ISO sensitivity. The aperture size corresponds to the F number of a camera, and the amount of blurring can be controlled by changing the aperture size. The transmittance is, for example, the transmittance of the material of a lens and may include that of a thin film applied to the lens. The thin film characteristic is the characteristic of a thin film, a representative example of which is transmittance, and may be include detailed information such as a characteristic due to oblique incidence. The manufacturing error is a variation during manufacturing and is an independent error for each individual unit. The ghost is a light image in which light reflected in a lens appears as the shape of an aperture stop, an ellipse, or the like when strong light enters the lens in backlight or the like. The flare is a phenomenon that fogging or unevenness appears on an image due to light reflection in a lens or a camera body. The noise corresponding to ISO sensitivity is noise that occurs when sensitivity is increased during shooting in a dark place or the like.

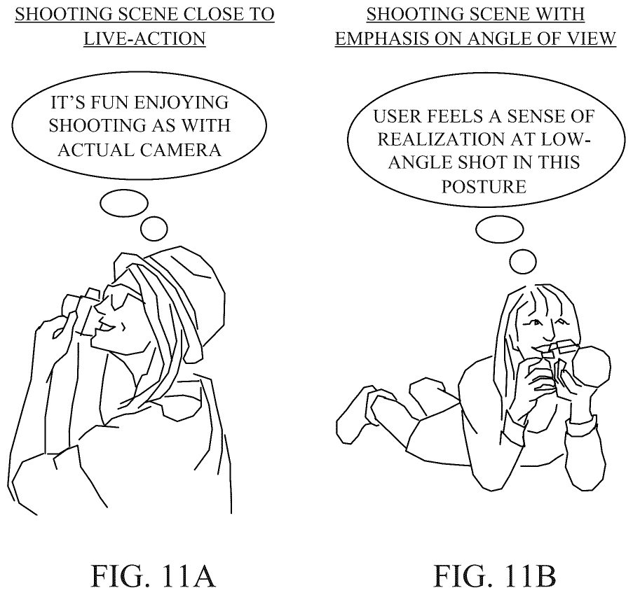

Using the camera-shaped medium having a variety of functions in this manner and described above in the first embodiment can perform shooting in a state as in real space. FIGS. 11A and 11B illustrate shooting scenes in this state.

FIG. 11A illustrates a shooting scene close to a live-action, in which shooting is performed during a walk in virtual space. Making movement close to a live-action can provide pseudo experience even in virtual space. It is conceivable that an impressive image can be captured in an environment as if shooting were actually performed.

FIG. 11B illustrates a shooting scene with emphasis on an angle of view. In this case, a sensor that senses height may be mounted. Thus, conceivably, performing shooting in a posture as in a live-action can capture an image having an impact as in a live-action.

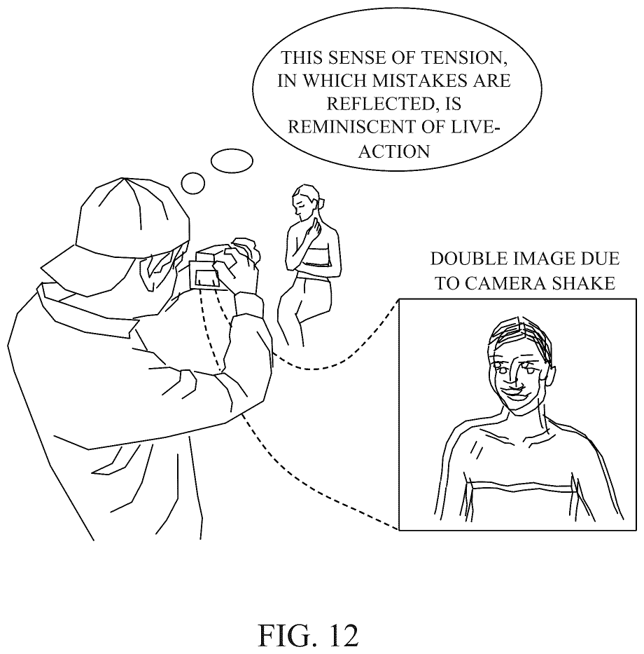

An image pickup apparatus in virtual space enables shooting with settings that match preferences. For example, even for a dynamic object, an image without blur can be acquired by infinitely reducing the shutter speed. In a case where a situation closer to a camera in real space is demanded, physical factors and setting errors that occur to a camera used in real space may be considered. More specifically, a method for acquiring an image in accordance with settings determined before shooting is conceivable. Thus, physical factors corresponding to a live-action may be incorporated into calculation of the characteristic of an image pickup apparatus. The physical factors may include camera shake of a controller (instrument) for instructing shooting instead of a camera. FIG. 12 illustrates a shooting scene close to a live-action. Since difficulty in a live-action can be experienced, a sense of tension increases, and as a result, an image full of realistic sensation can be acquired. In order to hold a photo contest with more realistic sensation, a rule that only images acquired in a state in which even setting errors are reflected can be submitted may be set.

Factors of setting errors corresponding to actual shooting may be incorporated into calculation of the characteristic of an image pickup apparatus. Overexposure or underexposure may be included as one factor of setting errors. In general, error removal has been mainstream in shooting in virtual space. However, incorporating these factors can provide shooting in a form close to reality.

An image thus obtained can be considered valuable. An image obtained in consideration of the characteristic of an image pickup apparatus may be highly evaluated in some cases. In a photo contest, an image refers to a work itself. The image may be recorded in an NFT in association with an image pickup apparatus. This corresponds to a situation in which an image as a work exists on the virtual space server 210 and is associated by the blockchain 250 in FIG. 2.

The above procedure this embodiment can provide an image that can be competed with an image based on the characteristic of a camera in real space.

### Fourth Embodiment

Shooting in virtual space is often performed in combination with a game. Assume the case where an image processing system described so far is used in a game. Calculation speed is often extremely prioritized in a game. While a still image generally requires high definition, a moving image for a game may not require definition as high as that of a still image. Accordingly, in a game as representative virtual space, a high-definition image may be output only when an image pickup apparatus is used in a camera mode corresponding to a state in which shooting is performed in the game. Specific processing includes increasing the definition of an object, increasing rendering density, and making a background a high-definition plane. Each processing may be performed independently or simultaneously.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

For example, this embodiment provides an image processing method configured to generate an image of an object using an imaging system in virtual space, and a unique characteristic of the imaging system is associated with an NFT recorded on a blockchain. The imaging system may include an image pickup apparatus that includes the optical system. Alternatively, the imaging system may include a camera body and an interchangeable lens attachable to and detachable from the camera body. In this case, the unique characteristic of the imaging system may include a unique characteristic of an interchangeable lens that includes the optical system and a unique characteristic of a camera body, and the unique characteristic of the interchangeable lens and the unique characteristic of the camera body may be separately associated with the NFT.

Each embodiment can provide an image processing method, image processing apparatus, and storage medium, each of which can acquire an image in accordance with the characteristic of an optical system (for example, a lens shape and a glass characteristic) included in an image pickup apparatus in virtual space.

What is claimed is:

1. An image processing method configured to generate an image of an object using an imaging system in virtual space, a unique characteristic of the imaging system being associated with an NFT recorded on a blockchain, the image processing method comprising:
acquiring a characteristic of an optical system included in the imaging system and spatial information on the object and the imaging system; and
generating the image using information on the object, the characteristic of the optical system, and the spatial information.

2. The image processing method according to claim 1, wherein the imaging system includes an image pickup apparatus that includes the optical system.

3. The image processing method according to claim 1, wherein the unique characteristic of the imaging system includes a unique characteristic of an interchangeable lens that includes the optical system and a unique characteristic of a camera body, and the unique characteristic of the interchangeable lens and the unique characteristic of the camera body are separately associated with the NFT.

4. The image processing method according to claim 1, wherein the image is generated by convolution of the characteristic of the optical system and a characteristic obtained based on the spatial information.

5. The image processing method according to claim 1, wherein the characteristic of the optical system corresponds to a characteristic of an optical system of an imaging system in real space.

6. The image processing method according to claim 1, wherein the characteristic of the optical system includes at least one of a PSF, a spot diagram, an aberration coefficient, and an aberration shape.

7. The image processing method according to claim 1, wherein the image is generated by classifying the spatial information into groups according to distance and performing occlusion processing.

8. The image processing method according to claim 1, wherein the image processing method is started according to an operation on an imaging system in real space.

9. The image processing method according to claim 8, wherein the imaging system in the real space corresponds to the imaging system in the virtual space and is associated with the NFT.

10. The image processing method according to claim 1, wherein the characteristic of the optical system includes at least one of an optical design value, a value indicating an imaging characteristic, and a control mechanism.

11. The image processing method according to claim 1, wherein the image is generated using the characteristic of the imaging system.

12. The image processing method according to claim 11, wherein the characteristic of the imaging system includes at least one of a transmittance, a thin film characteristic, a manufacturing error, ghost, and flare.

13. The image processing method according to claim 11, wherein the characteristic of the imaging system includes information on camera shake of a device that instructs shooting.

14. The image processing method according to claim 11, wherein the characteristic of the imaging system includes at least one of an aperture value, a shutter speed, an ISO sensitivity, an exposure, and a white balance correction.

15. The image processing method according to claim 1, further comprising recording, on the blockchain, the NFT associated with the image and the unique characteristic.

16. The image processing method according to claim 1, wherein the virtual space is space in a game, and
wherein the image processing method further comprises at least one of increasing definition of the object, increasing rendering density, and making a background a high-definition plane.

17. A non-transitory computer-readable storage medium storing a program that causes a computer to execute the image processing method according to claim 1.

18. An image processing apparatus configured to generate an image of an object using an imaging system in virtual space, a unique characteristic of the imaging system being associated with an NFT recorded on a blockchain, the image processing apparatus comprising:
one or more memories storing instructions; and
one or more processors that, upon execution of the instructions, operate to:
acquire a characteristic of an optical system included in the imaging system and spatial information on the object and the imaging system; and
generate the image using information on the object, the characteristic of the optical system, and the spatial information.

19. The image processing apparatus according to claim 18, wherein the one or more processors operate to change an association with the NFT when software is updated or when an purchased item is added.

20. The image processing apparatus according to claim 18, wherein only a specific user associated with the NFT is authorized to use the imaging system in the virtual space.
